(19) United States
(12) Patent Application Publication
(10) Pub. No.: US 2012/0153912 A1
(43) Pub. Date: Jun. 21, 2012

(54) Controller for a Power Converter and Method of Operating the Same

(76) Inventors: Jeffrey Demski, Orefield, PA (US); Douglas Dean Lopata, Boyertown, PA (US)

(21) Appl. No.: 12/971,166

(22) Filed: Dec. 17, 2010

(51) Int. Cl. G05F 1/46

(52) U.S. Cl. 323/282

(57) ABSTRACT

A controller, power converter and method of controlling a power switch therein to improve power conversion efficiency at low output current. In one embodiment, the power converter includes a power switch coupled to a source of electrical power, and a controller coupled to a control terminal of the power switch and to an output of the power converter. The controller is configured to control a conductivity of the power switch at a selected switching frequency from a set of discrete switching frequencies as a function of an output characteristic of the power converter.

### TECHNICAL FIELD

The present invention is directed, in general, to power electronics and, more specifically, to a controller, power converter and method of controlling a power switch therein to improve an efficiency of the power converter.

### BACKGROUND

A switch-mode power converter (also referred to as a “power converter” or “regulator”) is a power supply or power processing circuit that converts an input voltage waveform into a specified output voltage waveform. DC-DC power converters convert a direct current (“dc”) input voltage into a dc output voltage. Controllers associated with the power converters manage an operation thereof by controlling the conductivity of or conduction periods of power switches employed therein. Controllers may be coupled between an input and output of the power converter in a feedback loop configuration (also referred to as a “control loop” or “closed control loop”) to regulate an output characteristic (e.g., an output voltage, an output current, or a combination of an output voltage and an output current) of the power converter.

In an exemplary application, the power converters have the capability to convert an unregulated input voltage, such as 48 volts, supplied by a source of electrical power such as an input voltage source to a lower, unregulated, output voltage, such as 12 volts, to power a load. To provide the voltage conversion functions, the power converters include active power switches such as metal-oxide semiconductor field-effect transistors (“MOSFETs”) that are coupled to the voltage source and periodically switch the active switches at a switching frequency “fₛ” that may be on the order of one megahertz (“MHz”).

In typical applications of dc-dc power converters, power conversion efficiency is an important parameter that directly affects the physical size of the end product, its cost and market acceptance. Active power switches that are either fully on with low forward voltage drop or fully off with minimal leakage current provide a recognized advantage for power conversion efficiency in comparison with previous designs that utilized a dissipative “pass” transistor to regulate an output characteristic or a passive diode to provide a rectification function. Previous designs using pass transistors and passive diodes produced operating power conversion efficiencies of roughly 40-70 percent (“%”) in many applications. The use of active power switches in many recent power converter designs, particularly as synchronous rectifiers for low output voltages, has increased operating efficiency at full rated load to 90% or more.

A continuing problem with power converters is preserving power conversion efficiency at low levels of output current. Unregulated power converters with fixed conversion ratios (e.g., switched-capacitor power converters or isolated-transformer power converters with fixed step-down or step-up ratios such as bus power converters) generally operate at a fixed switching frequency with a fixed duty cycle. However, as is well known in the art, as the output load current of the power converter drops, the converter delivers less power, but fixed losses in the power stage do not drop, which results in lower power conversion efficiency at light loads. Low efficiency at light loads is a result of power inherently lost by parasitic elements in power switches and reactive components such as internal resistances and by losses induced by imperfect switching action of the power switches. Imperfect switching action results from the need to charge parasitic circuit capacitances and to absorb reverse recovery charge of bipolar diodes. Further losses are also generated in the control and drive circuits coupled to the active power switches. Ultimately, as the output current of a power converter approaches zero, the fixed losses in the power switches, reactive circuit elements and control circuits cause power conversion efficiency also to approach zero.

The problem of low power conversion efficiency at light loads has been addressed using a control loop that senses the variation in output voltage, which is indicative of the level of the load, and uses that indication to adjust the switching frequency fₛ of the power stage. A reduction of switching frequency reduces fixed power losses when an increase in the output voltage is sensed, which is indicative of a decrease in load current.

One such frequency-control approach is described in U.S. Pat. No. 7,612,603, entitled “Switching Frequency Control of Switched Capacitor Circuit Using Output Voltage Droop,” to Petricek, et al. (“Petricek”), issued Nov. 3, 2009, which is incorporated herein by reference. An exemplary switched-capacitor power conversion topology is shown in Petricek that develops an output voltage that is about one-half the input voltage. Petricek teaches the use of an analog control loop that continuously monitors the output voltage to produce a continuously changing switching frequency. While this achieves the desired efficiency result, its main drawback is that it generates a large spectrum of frequencies that are substantially unpredictable in nature. Therefore, in noise-sensitive applications such noise is virtually impossible to predict and to filter out of the system.

Another approach to improve power conversion efficiency at low output currents, as described by X. Zhou, et al. (“Zhou”), in a reference entitled “Improved Light-Load Efficiency for Synchronous Rectifier Voltage Regulation Module,” IEEE Transactions on Power Electronics, Volume 15, Number 5, September 2000, pp. 826-834, which is incorporated herein by reference, utilizes duty cycle adjustments to adjust switching frequency or to disable a synchronous rectifier switch. A further approach, as described in U.S. Pat. No. 6,580,258, entitled “Control Circuit and Method for Maintaining High Efficiency Over Broad Current Ranges in a Switching Regulator Circuit,” to M. E. Wilcox, et al. (“Wilcox”), issued Jun. 17, 2003, which is incorporated herein by reference, generates a control signal to intermittently turn off one or more active power switches under light load operating conditions when the output voltage of the power converter can be maintained at a regulated voltage by the charge on an output capacitor. Of course, when an output voltage from a power converter is temporarily discontinued, such as when the load coupled thereto is not performing an active function, the power converter can be disabled by an enable/disable signal, generated either at a system or manual level, which is a process commonly used, even in quite early power converter designs.

However, a system that alters the switching frequency in an unpredictable manner to improve power conversion efficiency produces a wide-frequency spectrum that can induce electromagnetic interference (“EMI”) in neighboring electronic equipment. Thus, the problem of providing high power conversion efficiency at light load currents still remains an unresolved issue. Accordingly, what is needed in the art is a power converter and related method of operating the same to provide high power conversion efficiency, especially at light load currents, that overcomes deficiencies in the prior art.

### SUMMARY OF THE INVENTION

These and other problems are generally solved or circumvented, and technical advantages are generally achieved, by advantageous embodiments of the present invention, including a controller, power converter and method of controlling a power switch therein to improve power conversion efficiency at low output current. In one embodiment, the power converter includes a power switch coupled to a source of electrical power, and a controller coupled to a control terminal of the power switch and to an output of the power converter. The controller is configured to control a conductivity of the power switch at a selected switching frequency from a set of discrete switching frequencies as a function of an output characteristic of the power converter.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of an embodiment of a power converter constructed according to the principles of the present invention;

FIG. 2 illustrates a schematic diagram of an embodiment of portions of a power converter constructed according to the principles of the present invention;

FIG. 3 illustrates a schematic diagram of an embodiment of a controller constructed according to the principles of the present invention;

FIG. 4 illustrates a flowchart of an embodiment of a method of operating a controller of a power converter according to the principles of the present invention; and

FIG. 5 illustrates a schematic diagram of an embodiment of a controller constructed according to the principles of the present invention.

Corresponding numerals and symbols in the different figures generally refer to corresponding parts unless otherwise indicated, and may not be redescribed in the interest of brevity after the first instance. The FIGUREs are drawn to illustrate clearly the relevant aspects of exemplary embodiments.

### DETAILED DESCRIPTION OF ILLUSTRATIVE EMBODIMENTS

The making and using of the presently exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to exemplary embodiments in a specific context, namely, a power converter including a controller responsive to an output characteristic (e.g., a level of output voltage) to control a switching frequency therein and methods of operating the same. While the principles of the present invention will be described in the environment of a power converter, any application that may benefit from power conversion, such as a power amplifier, including a controller responsive to an output characteristic to control a switching frequency therein is well within the broad scope of the present invention.

A load coupled to a power converter may sometimes operate for a period of time in a low-power mode of operation wherein the load draws a relatively small, but non-zero current from the power converter (e.g., 10% or less of its normal load current). Under such operating conditions, wherein power conversion efficiency of the power converter is typically very low, it is desirable to provide high power conversion efficiency, particularly when the power converter is powered from a source of electrical power such as a portable energy source (e.g., a battery).

As introduced herein, a controller senses an output characteristic of a power converter and reduces a switching frequency of the power converter in a number (e.g., small number such as four) of discrete steps to increase power conversion efficiency as a load decreases. The controller may sense the load coupled to an unregulated power converter by sensing a change in an unregulated output voltage. An increase in the output voltage is employed as an indicator of a reduction of load current. The controller may sense the load coupled to a regulated power converter by directly sensing the load current or by sensing an internal current such as a current flowing through a power switch or a reactive circuit element such as an inductor. A current can be sensed, without limitation, by an operational amplifier coupled to a current-sensing resistor, or by a current-sensing transformer, regardless of whether the power converter is regulated or not.

An analog-to-digital converter (“ADC”) with coarse quantization is employed to translate a continuously varying characteristic such as an output voltage of a power converter (e.g., an unregulated power converter) into a voltage value from a finite set of fixed, discrete voltage levels, which may be a predetermined set of voltage levels. The selected voltage value is then translated into a frequency of choice, which may be a predetermined frequency. The frequency choices are selected from a set of frequency values using a logic module, or otherwise. One method employs a chained frequency divider coupled to a clock with a substantially fixed frequency to convert a fixed frequency of the clock down to a fractional frequency with taps corresponding to the discrete voltage values.

To obtain a significant improvement in power conversion efficiency as the load coupled to the power converter is reduced, a significant change, such as at least a two-to-one change, is generally made in a switching frequency of the power converter. A conventional controller that substantially and continuously adjusts switching frequency over a wide range of frequencies produces conducted and radiated spectral elements over a correspondingly wide range of frequencies that can stimulate resonant responses in unpredictable circuit arrangements that can be coupled to the power converter. By restricting switching frequencies to a small set of discrete values, the amount of testing and analysis that may be performed to assure compliance with a specified electromagnetic interference (“EMI”) performance level is reduced to a practical level. In an exemplary design as described hereinbelow, a switching frequency fₛ is varied over a frequency range of 8:1 employing four discrete frequency values.

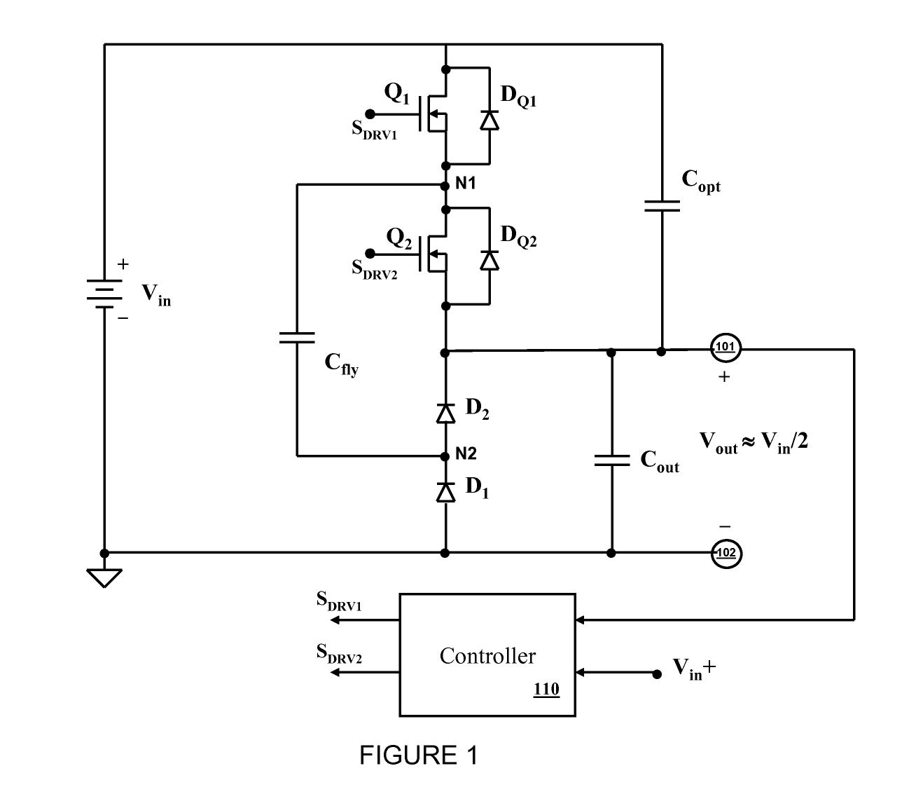

Referring initially to FIG. 1, illustrated is a schematic diagram of an embodiment of a power converter constructed according to the principles of the present invention. The power converter is a switched-capacitor dc-dc power converter configured to divide a source of electrical power such as a dc input voltage source represented by battery Vᵢₙ by a factor of two to produce an output voltage Vₒᵤₜ. While in the illustrated power converter the power train employs a switched-capacitor power converter topology, those skilled in the art should understand that other power converter topologies such as a buck, buck-boost, forward, Cúk, etc., power converter topology are well within the broad scope of the present invention. The switched-capacitor dc-dc power converter illustrated in FIG. 1 employs first and second power switches Q₁, Q₂, first and second diodes D₁, D₂, a flying capacitor C_{fly}, an output capacitor Cₒᵤₜ, and a controller 110 (including a processor and memory). The first and second body diodes D_{Q1}, D_{Q2} represent body diodes of the first and second power switches Q₁, Q₂. The switched-capacitor dc-dc power converter illustrated in FIG. 1 and variations thereof, for example, as described in U.S. Patent Application Publication No. 2007/0296383, entitled “Non-Isolated Bus Converters with Voltage Divider Topology,” to Xu, et al., published Dec. 27, 2007, which is incorporated herein by reference, can be configured to provide high power conversion density and high power conversion efficiency.

The first power switch Q₁ has a drain coupled to a source of electrical power (e.g., an input voltage source to provide an input voltage Vᵢₙ) and a source coupled to a first node N1. The second power switch Q₂ has a drain coupled to the first node N1 and a source coupled to an output node 101 to produce the output voltage Vₒᵤₜ. The second diode D₂ has an anode coupled to the output node 101 and a cathode coupled to a second node N2. The first diode D₁ has an anode coupled to the first node N1 and a cathode coupled to local circuit ground. A flying capacitor C_{fly} is coupled between the output nodes 101, 102. The output power is provided from the output nodes 101, 102.

During a first interval of a switching cycle, the first power switch Q₁, [e.g., an re-channel metal oxide semiconductor field effect transistor (“MOSFET”)], is enabled to conduct by the controller 110 employing a gate-drive signal S_{DRV1}, and conductivity of the second power switch Q₂ is disabled by the controller 110 employing a gate-drive signal S_{DRV2}. This switching action at a switching frequency fₛ causes the top terminal of the flying capacitor C_{fly} to be coupled to input voltage source and the bottom terminal of the flying capacitor C_{fly} to be coupled through the second diode D₂ to the top terminal of the output capacitor Cₒᵤₜ. This causes the flying capacitor C_{fly} and the output capacitor Cₒᵤₜ each to be charged in series to about one-half the input voltage Vᵢₙ. The voltages produced across the output and flying capacitors Cₒᵤₜ, C_{fly} are generally unequal.

During a complementary interval of the switching cycle, the second power switch Q2 is enabled to conduct by the controller 110 employing the gate-drive signal S_{DRV2}, and the first power switch Q₁ is transitioned to a nonconducting state by the controller 110 employing the gate-drive signal S_{DRV1}. Those skilled in the art should understand, however, that the conduction periods for the first and second power switches Q₁, Q₂ may be separated by a small time interval to avoid cross conduction therebetween and beneficially to reduce the switching losses associated with the power converter. This switching action causes the top terminal of flying capacitor C_{fly} to be coupled to the output capacitor Cₒᵤₜ, and the bottom terminal of the flying capacitor C_{fly} to be coupled through the first diode D₁ to the bottom terminal of output capacitor Cₒᵤₜ. This causes flying capacitor C_{fly} and output capacitor Cₒᵤₜ to substantially equalize their voltages, again, at about one-half the input voltage Vᵢₙ. The flying capacitor C_{fly} typically discharges a small portion of its charge into the output capacitor Cₒᵤₜ, which will be partially discharged by a load (not shown) coupled to output terminals 101, 102.

As is well known in the art, the first and second diodes D₁, D₂ can be replaced with active switches such as MOSFETs to improve power conversion efficiency. In addition, portions of the switched-capacitor dc-dc power converter illustrated in FIG. 1 can be replicated to provide a higher voltage-dividing factor, such as a voltage-dividing factor of three, four or more. Replication of portions of a switched-capacitor dc-dc power converter to provide a higher voltage-dividing factor are described by P. Chhawchharia, et al., in a reference entitled “On the Reduction of Component Count in Switched Capacitor DC/DC Converters,” PESC Record, Vol. 2, June 1997, pp. 1395-1401, which is incorporated herein by reference. It is recognized that a switched-capacitor dc-dc power converter does not precisely divide an input voltage by an integer, due to inherent losses in such circuits. In general, the output voltage of a switched-capacitor dc-dc power converter decreases as the load on the power converter increases.

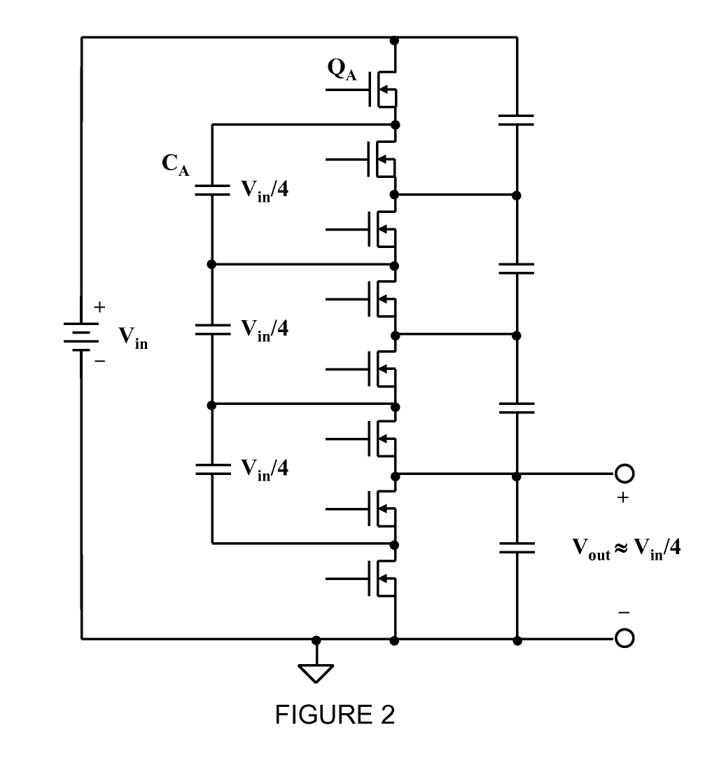

Turning now to FIG. 2, illustrated is a schematic diagram of an embodiment of portions of a power converter (to provide a voltage dividing factor of four) constructed according to the principles of the present invention. The power converter is formed with eight N-channel MOSFETs (“NMOS”) switches (one of which is designated QA) and seven capacitors (one of which is designated C_{A}), all preferably substantially equal in capacitance. The operation of the power converter illustrated in FIG. 2 is similar to that of the power converter illustrated in FIG. 1, and will not be described herein in the interest of brevity.

The controller 110 illustrated in FIG. 1 may be formed with a driver (e.g., a gate driver) to provide the gate-drive signals S_{DRV1}, S_{DRV2} to control the respective conductivities of the first and second power switches Q₁, Q₂. There are a number of viable alternatives to implement a driver that include techniques to provide sufficient signal delays to prevent crosscurrents when controlling multiple power switches in the power converter. The driver typically includes switching circuitry incorporating a plurality of driver switches that cooperate to provide the gate-drive signals S_{DRV1}, S_{DRV2} to the first and second power switches Q₁, Q₂. Of course, any driver capable of providing the gate-drive signals S_{DRV1}, S_{DRV2} to control a power switch is well within the broad scope of the present invention. As an example, a driver is disclosed in U.S. Pat. No. 7,330,017, entitled “Driver for a Power Converter and a Method of Driving a Switch Thereof,” to Dwarakanath, et al., issued Feb. 12, 2008, and a power switch is disclosed in U.S. Pat. No. 7,230,302, entitled “Laterally Diffused Metal Oxide Semiconductor Device and Method of Forming the Same,” to Lotfi, et al., issued Jun. 12, 2007 and in U.S. Pat. No. 7,214,985, entitled “Integrated Circuit Incorporating Higher Voltage Devices and Low Voltage Devices Therein,” to Lotfi, et al., issued May 8, 2007, which are incorporated herein by reference.

The controller 110 of the power converter receives an output characteristic (e.g., the output voltage Vₒᵤₜ) of the power converter. The controller 110 of the power converter is also coupled to the input voltage Vᵢₙ. The output voltage Vₒᵤₜ and the input voltage Vᵢₙ are employed by controller 110 to control the switching frequency fₛ of the power converter as described further hereinbelow. For exemplary controllers, see U.S. Pat. No. 7,038,438, entitled “Controller for a Power Converter and Method of Controlling a Switch Thereof,” to Dwarakanath, et al., issued May 2, 2006, and U.S. Pat. No. 7,019,505, entitled “Digital Controller for a Power Converter Employing Selectable Phases of a Clock Signal,” to Dwarakanath, et al., issued Mar. 28, 2006, which are incorporated herein by reference.

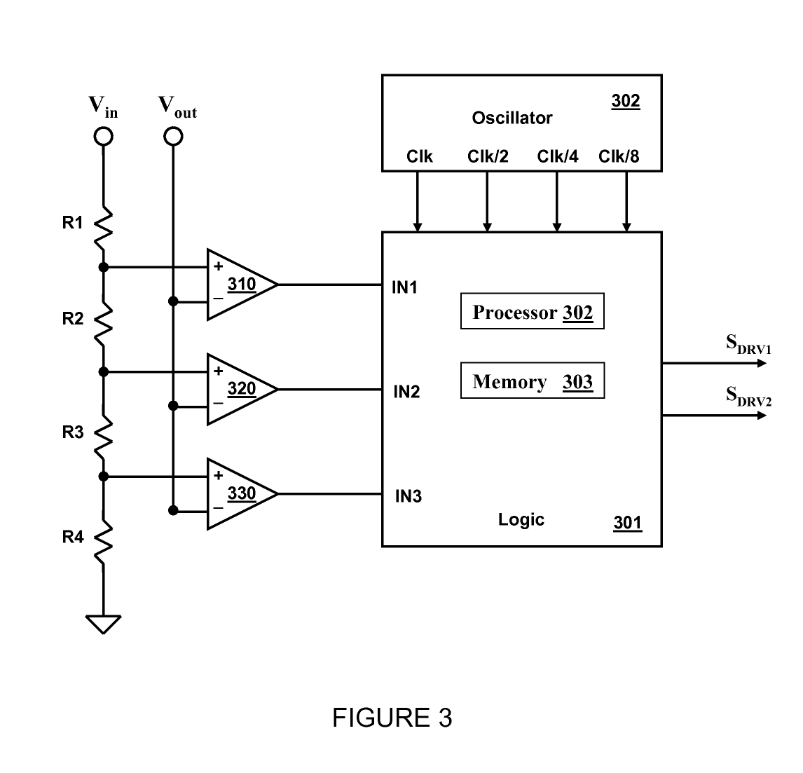

Turning now to FIG. 3, illustrated is a schematic diagram of an embodiment of a controller (or portions thereof) constructed according to the principles of the present invention. A source of electrical power such as an input voltage source provides an input voltage Vᵢₙ coupled to a voltage divider network formed with first, second, third and fourth resistors R1, R2, R3, R4. The circuit nodes between the resistors are coupled respectively to the respective noninverting inputs of first, second and third comparators 310, 320, 330. The inverting inputs of the first, second and third comparators 310, 320, 330 are collectively coupled to an output voltage Vₒᵤₜ. A logic module 301 senses the outputs of the first, second and third comparators 310, 320, 330 as first, second and third inputs IN1, IN2, IN3. The logic module 301 is also coupled to an oscillator 305 that provides clock signals at the frequencies Clk, Clk/2, Clk/4, Clk/8. The lower frequencies of the clock signals are produced by the oscillator 305 by successively dividing in half the frequency Clk with a chain of frequency dividers. By employing the voltage divider network formed with the first, second, third and fourth resistors R1, R2, R3, R4, the controller is responsive to a ratio of the output voltage Vₒᵤₜ to the input voltage Vᵢₙ. In the illustrated embodiment, the logic module 301 includes a processor 302 and memory 303 to perform its intended function.

The first, second, third and fourth resistors R1, R2, R3, R4 are selected to provide a relatively small separation of voltages at which the first, second and third comparators 310, 320, 330 switch. For example, for a power converter with a nominal 12 volt output, the first, second, third and fourth resistors R1, R2, R3, R4 may be selected so that the first comparator 310 switches at 11.8 volts, the second comparator 320 switches at 11.6 volts, and the third comparator 330 switches at 11.4 volts. In this way, the logic module 301 can respond with a change in switching frequency to a small change in output voltage Vₒᵤₜ of the power converter. The logic module 301 produces at its output gate-drive signals S_{DRV1}, S_{DRV2}. The gate-drive signals S_{DRV1}, S_{DRV2} for high-side switches, such as the first and second power switches Q₁, Q₂ illustrated in FIG. 1, can be produced from a low-level logic signal by a high-side driver, such as the high-side driver AUIRS2016S produced by International Rectifier and described in the datasheet entitled “Automotive Grade AUIRS2016S™,” dated Jan. 26, 2009, which is hereby incorporated herein by reference. An alternative high-side gate-driving arrangement is described in U.S. Pat. No. 5,481,219, entitled “Apparatus and Method for Generating Negative Bias for Isolated MOSFET Gate-Drive Circuits,” to Jacobs, et al., which is incorporated herein by reference.

The processor 302 of the logic module 310 may be any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples. The memory 303 of the logic module 301 may include one or more memories of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory may include program instructions or computer program code that, when executed by an associated processor, enable the logic module 301 to perform tasks as described herein. The logic module 301 may be implemented in accordance with hardware (embodied in one or more chips including an integrated circuit such as an application specific integrated circuit), or may be implemented as software or firmware for execution by a processor. In particular, in the case of firmware or software, the exemplary embodiment can be provided as a computer program product including a computer readable medium or storage structure embodying computer program code (i.e., software or firmware) thereon for execution by the processor.

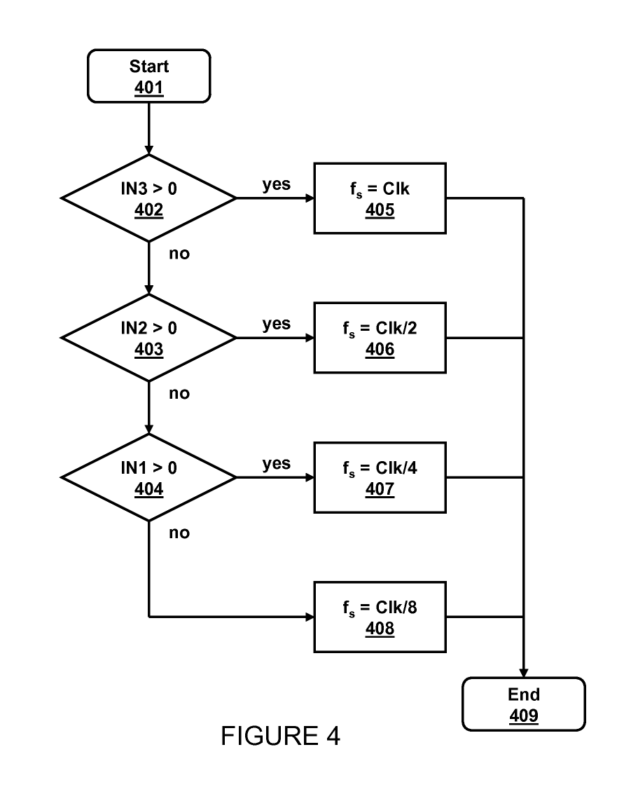

Turning now to FIG. 4, illustrated is a flowchart of an embodiment of a method of operating a controller of a power converter according to the principles of the present invention. For purposes of clarity, the method will be described with respect to the controller of FIG. 3 showing a logical process to select one of the four switching frequencies fₛ produced by the oscillator 305. The method begins at a step or module 401. At a step or module 402, the third input IN3 of the logic module 301 is compared against the threshold voltage level 0 volts. If the third input IN3 is greater than 0 volts, then the switching frequency fₛ is set in a step or module 405 to the frequency Clk produced by the oscillator 305. If the third input IN3 is not greater than 0 volts, then the method continues to a step or module 403 wherein the second input IN2 of the logic module 301 is then compared against the threshold voltage level 0 volts. If the second input IN2 is greater than 0 volts, then switching frequency fₛ is set in a step or module 406 to the frequency Clk/2 produced by the oscillator 305. If the second input IN2 is not greater than 0 volts, then the method continues to a step or module 404 wherein the first input IN1 of the logic module 301 is then compared against the threshold voltage level 0 volts. If the first input IN1 is greater than 0 volts, then switching frequency fₛ is set in a step or module 407 to the frequency Clk/4 produced by the oscillator 305. If the first input IN1 is not greater than 0 volts, then switching frequency fₛ is set in a step or module 408 to the frequency Clk/8 produced by the oscillator 305. After the switching frequency fₛ has been set in any one of the steps or modules above, the method ends at a step or module 409.

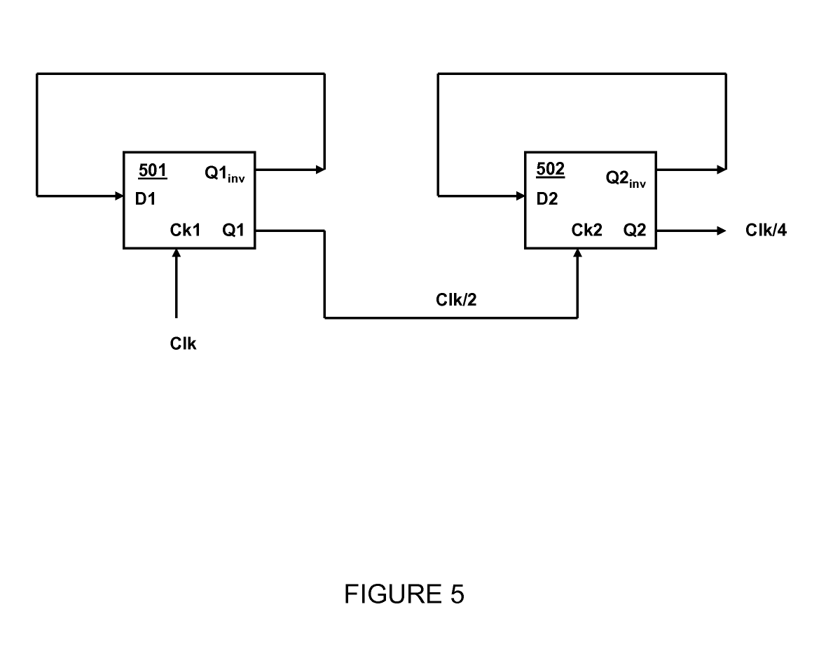

Turning now to FIG. 5, illustrated is a schematic diagram of an embodiment of a controller (or portions thereof) constructed according to the principles of the present invention. The controller includes first and second delay-type (“D-type”) flip-flops 501, 502 configured to divide by two the frequency of a clock signal Clk. The clock signal Clk is applied to a clock input Ck1 of the first D-type flip-flop 501. The inverted output Q1ᵢₙᵥ of the first D-type flip-flop 501 is coupled to its D-input D1. The output Q1 of the first D-type flip-flop 501 only changes state in response to its D-input D1 on a positive going edge of the clock signal Clk. The output Q1 of the first D-type flip-flop 501 requires two changes to complete a cycle. Thus, the output Q1 from the first D-type flip-flop 501 changes at half the rate (i.e., Clk/2) of the clock signal Clk. Similarly, the output Q2 of the second D-type flip-flop 502 changes at half the rate of its respective clock signal coupled to its clock input Ck2. The output signal of the chained pair of D-type flip-flops 501, 502 changes at one quarter the rate (i.e., Clk/4) of the clock signal Clk. By further chaining of D-type flip-flops, frequency division by a factor of four, eight, etc., can be readily obtained. Integer frequency division of a clock signal can also be obtained with a shift register, as is well known in the art. Non-integer frequency division can also be obtained employing phase-locked loops and delta-sigma dividers, as is well known in the art.

Thus, as illustrated and described with reference to the accompanying drawings, a controller for a power converter (e.g., a switched-capacitor power converter) and method of operating the same has been introduced herein. In one embodiment, the power converter includes a power switch coupled to a source of electrical power, and a controller coupled to a control terminal of the power switch and to an output of the power converter. The controller is configured to control a conductivity of the power switch at a selected switching frequency from a set of discrete switching frequencies (e.g., four switching frequencies that span a frequency range of 8:1) as a function of an output characteristic (e.g., an unregulated output characteristic) of the power converter. The selected switching frequency may be reduced in discrete steps as the output characteristic increases, and the selected switching frequency may be dependent on a ratio of an output voltage to an input voltage of the power converter. Additionally, the controller may include at least one frequency divider to produce the set of discrete switching frequencies.

Those skilled in the art should understand that the previously described embodiments of a power converter and related methods of constructing the same are submitted for illustrative purposes only. In addition, other embodiments capable of producing a power converter employable with other switch-mode power converter topologies are well within the broad scope of the present invention. While the power converter has been described in the environment of a power converter including a controller to control an output characteristic to power a load, the power converter including a controller may also be applied to other systems such as a power amplifier, a motor controller, and a system to control an actuator in accordance with a stepper motor or other electromechanical device.

For a better understanding of power converters, see “Modern DC-to-DC Switchmode Power Converter Circuits,” by Rudolph P. Severns and Gordon Bloom, Van Nostrand Reinhold Company, New York, N.Y. (1985) and “Principles of Power Electronics,” by J. G. Kassakian, M. F. Schlecht and G. C. Verghese, Addison-Wesley (1991). The aforementioned references are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A controller, coupled to a control terminal of a power switch and to an output of a power converter, configured to control a conductivity of said power switch at a selected switching frequency from a set of discrete switching frequencies as a function of an output characteristic of said power converter.

2. The controller as recited in claim 1 wherein said output characteristic is an unregulated output characteristic.

3. The controller as recited in claim 1 wherein said set of discrete switching frequencies include four switching frequencies that span a frequency range of eight to one.

4. The controller as recited in claim 1 wherein said selected switching frequency is reduced in discrete steps as said output characteristic increases.

5. The controller as recited in claim 1 wherein said selected switching frequency is dependent on a ratio of an output voltage to an input voltage of said power converter.

6. The controller as recited in claim 1 wherein controller includes at least one frequency divider to produce said set of discrete switching frequencies.

7. A power converter, comprising:
a power switch coupled to a source of electrical power; and
a controller, coupled to a control terminal of said power switch and to an output of said power converter, configured to control a conductivity of said power switch at a selected switching frequency from a set of discrete switching frequencies as a function of an output characteristic of said power converter.

8. The power converter as recited in claim 7 wherein said output characteristic is an unregulated output characteristic.

9. The power converter as recited in claim 7 wherein said set of discrete switching frequencies include four switching frequencies that span a frequency range of eight to one.

10. The power converter as recited in claim 7 wherein said selected switching frequency is reduced in discrete steps as said output characteristic increases.

11. The power converter as recited in claim 7 wherein said selected switching frequency is dependent on a ratio of an output voltage to an input voltage of said power converter.

12. The power converter as recited in claim 7 wherein controller includes at least one frequency divider to produce said set of discrete switching frequencies.

13. The power converter as recited in claim 7 wherein said power converter is a switched-capacitor power converter.

14. A method of operating a power converter, comprising:
coupling a power switch to a source of electrical power;
controlling a conductivity of said power switch at a selected switching frequency from a set of discrete switching frequencies as a function of an output characteristic of said power converter.

15. The method as recited in claim 14 wherein said output characteristic is an unregulated output characteristic.

16. The method as recited in claim 14 wherein said set of discrete switching frequencies include four switching frequencies that span a frequency range of eight to one.

17. The method as recited in claim 14 wherein said selected switching frequency is reduced in discrete steps as said output characteristic increases.

18. The method as recited in claim 14 wherein said selected switching frequency is dependent on a ratio of an output voltage to an input voltage of said power converter.

19. The method as recited in claim 14 wherein said set of discrete switching frequencies are produced with at least one frequency divider.

20. The method as recited in claim 14 wherein said power converter is a switched-capacitor power converter.
